(19) United States
(12) Patent Application Publication
(10) Pub. No.: US 2008/0238871 A1
(43) Pub. Date: Oct. 2, 2008

(54) Display apparatus and method for operating a display apparatus

(75) Inventor: Simon Tam, Cambridgeshire (GB)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/078,277

(22) Filed: Mar. 28, 2008

(30) Foreign Application Priority Data
Mar. 30, 2007 (GB) 0706318.3

(51) Int. Cl. G09G 3/38; G06F 3/033; G09G 5/00

(52) U.S. Cl. 345/158; 345/179; 345/105; 178/18.01

(57) ABSTRACT

A display apparatus includes a plurality of scanning lines and data lines and, at each intersection of said data lines and scanning lines, an electrochromic pixel element and a sensor element connected to the pixel element. The sensor element is sensitive to a user's graphical input, which changes a charge state of the respective pixel element. The display apparatus also includes a control means, which is configured to allow the pixel element to be selectively set to a first charge state corresponding to a first display state, or to a second charge state corresponding to a second display state. The second display state reflects the user's graphical input. The second charge state of the pixels may be brought about by exposing the sensor elements to light from a light pen or to a magnetic field from a magnetic pen, the pen being drawn across the display screen of the apparatus. Due to the direct action of the sensor elements in modulating the charge on the pixel elements, it is possible to display an image drawn on the screen instantly, without the need to scan the display to determine which pixels have changed their initial charge. This reduces the power consumption of the apparatus.

### I. TECHNICAL FIELD

Several aspects of the present invention relate to a display apparatus and method for operating a display apparatus.

### II. BACKGROUND

Modern computing technologies have reshaped the way people perceive and enter data. It is common for information to be displayed on a screen and for data to be entered using a keyboard and a pointing device, e.g. a mouse. The pointing device is used to activate the appropriate field and the keyboard is used to enter data into that field. This procedure, however, can be quite inefficient, due to the time wasted in manipulating the pointing device. To mitigate this problem, displays having an integrated pointing device, sometimes referred to as “interactive displays”, are becoming popular, since they can be tailored for specific purposes. In particular, a form of interactive display known as the “touch-sensitive display” is commonly employed at supermarket check-outs and in phone booths, personal data devices and notebook computers, for example.

An interactive display usually includes a sensing layer. A detection circuit is used to interrogate the sensing layer and continuously translate the resulting interrogation signal into the current x-y co-ordinates of a pointing device (e.g. a finger tip or the tip of a dummy pen, which is in contact with the display screen). The x-y co-ordinates are passed to the system controller, which takes the appropriate action, such as moving the mouse cursor or changing the colour of a pixel located under the cursor. The updated image is displayed via a display controller. Because the system controller and the display operate at MHz frequencies, the display is updated in real-time. Consequently, the display can show what the user has written or drawn. In addition, the system controller can even perform functions such as character recognition.

One example of such a system is described in U.S. Pat. No. 6,964,022. This relates to the interactive “white board” commonly found in modern-day classrooms. A drawback of this system, however, is that it is not a portable device and it requires the pointer location to be processed continuously, thereby increasing the power consumption.

Another example is disclosed in U.S. Pat. No. 7,109,967. The device described in this patent consists of a form-change detection unit 10, as shown in FIG. 1A. The form-change detection unit 10 comprises a perception layer 12 interposed between a pair of electrode layers 14 and 16. The resistance of the perception layer changes with applied stress, which is caused by a pointing device (e.g. a pen) being pressed down onto the perception layer. FIG. 1B shows a pen 18 being used to draw a diagram on a touch panel 20, below which is the perception layer, etc. The form-change detection unit passes the resistance-change information to a signal-judging unit, which judges the input information and subsequently the display drive unit provides a corresponding handwriting output on the display.

Other types of detection technology, such as electromagnetic induction sensing (see, for example, U.S. Pat. No. 8,149,647), motion sensing (see, for example, US 2006/0176288) and capacitive sensing (see, for example, US 2005/0162410) have also been discussed. These technologies have the advantage of being portable, but the sensing circuits, and in particular the processing units, consume power while the user inputs his handwriting on the screen.

Recently, bi-stable displays (e.g. electrophoretic displays and electrochromic displays) have attracted a great deal of attention due to their light weight, re-writability and ability to retain an image over a long period. These displays only consume power while an image is being written. They are suitable for portable applications that have stringent power-consumption requirements. Commercial products based on these technologies include Sony's e-book and Seiko Epson's EPD watches. More recently, Seiko Epson has demonstrated 7-inch flexible EPD displays (“A Flexible 7.1-inch Active-Matrix Electrophoretic Display,” by Y. Komatsu, et. al., in SID Symposium Digest of Technical Papers, Vol. 37, pp. 1830-1833, June 2006.), which help to make electronic paper a reality. A working bi-stable electrochromic display was demonstrated at the same conference—see “The Design and Driving of Active-Matrix Electrochromic Displays Driven by LTPS TFTs,” by S. Tam, et. al., in SID Symposium Digest of Technical Papers, Vol. 37, pp. 33-36, June 2006. However, there is currently no interactive user interface for such electronic paper displays.

U.S. Pat. No. 6,974,917 and U.S. Pat. No. 7,098,898 disclose a bi-stable digital paper made up of rewritable colour thermochromic pixel elements, that change between transparent and black states. The data on the digital paper can contain pre-printed information and a heating pen can be used to input additional writing. The pen also has additional components to couple with a digitizer in order to form an electromagnetic induction-type handwriting input. FIGS. 2A and 2B illustrate such an arrangement. FIG. 2A is a system diagram for this handwriting input scheme, while FIG. 2B shows the heating pen 30 being used to enter information onto the thermochromic digital paper 32. Each “sheet” of digital paper has a unique barcode 34, which corresponds to a record on the computer system and is used in conjunction with a barcode reader 36. Although the writing process on the digital paper does not itself consume power, power is still required for the digitizer during the entire period in which the user is inputting his handwriting.

In U.S. Pat. No. 5,194,852, a portable interactive electro-optic data input/output display device is described, which is responsive to hand-printed text and hand-drawn graphics. A system diagram of this device is included herewith as FIG. 3. In FIG. 3, an active matrix addressed display backplane 40 comprises a continuous sheet of conductive transparent material for sensing the position of an input pen 42. While the device is displaying data, the backplane 40 is connected to a display unit 44, via an analog switch 46, so as to enable it to operate as a conventional backplane. For brief intervals, which are imperceptible to a user, the backplane 40 is connected via a switch 46 to a position sensing unit 48, so that the backplane acts as a resistive position sensor for these intervals. During position sensing, an input pen signal from a pen signal source 50 is fed to the input pen 42. The input pen signal is capacitively coupled through the top glass onto the backplane 40. The position of the input pen can be detected due to a varying impedance between the input pen tip 52 and the edges 54 of the backplane. The impedance depends upon the distance between the pen tip 52 and the backplane edges 54.

Again, in this system power is required during the whole of the time in which the user is inputting his handwriting.

### III. BRIEF SUMMARY OF THE INVENTION

In the prior-art devices discussed, digitizers are used, which are required to be continuously switched on in order to provide a sensing function. In addition, the displays have to be continuously updated in order to show the latest state of the handwritten data. This means that power is consumed for as long as the user enters handwritten data. It is the aim of the present invention to mitigate these drawbacks associated with the known devices, thereby either extending the operating time of the battery used or allowing the use of a smaller battery, resulting in a more compact and lighter device.

In accordance with a first aspect of the present invention there is provided a display apparatus comprising: a plurality of scanning lines and data lines and, at each intersection of said data lines and scanning lines: an electrochromic pixel element, and a sensor element connected to said pixel element, the sensor element being sensitive to a user's graphical input, thereby to change a charge state of the respective pixel element; the display apparatus further comprising: a control means, which is configured to allow said pixel element to be selectively set to a first charge state corresponding to a first display state, or to a second charge state corresponding to a second display state, said second display state reflecting the user's graphical input.

The control means may include, for each said intersection of said data lines and scanning lines, a first switch means, which is connected to the respective data line and is configured to selectively connect that data line to an input video signal for setting the pixel element to the first charge state, or to a charge-sensing circuit for reading out the second charge state of the pixel element.

The control means is preferably configured to perform three sequential phases of operation: a pre-charge phase, in which said first charge state of the pixel element is set; an exposure phase, in which the sensor element is exposed to said user's graphical input, and a readout phase, in which said second charge state of the pixel element is read out.

One end of said pixel element and one end of said sensor element may be coupled to each other, the other end of said pixel element being connected to a common voltage for all of the pixel elements, and the other end of said sensor element being connected to a reference voltage.

The display apparatus is advantageously an active-matrix display apparatus, comprising a second switch means connected to said data line and to said pixel element and controlled by a respective scanning line.

The control means may be configured such that: in said pre-charge phase, said second switch means is switched on, thereby to connect said pixel element and said sensor element to said data line; said first switch means connects said data line to said input video signal; said input video signal is at a low voltage level; said common voltage is at a high voltage level and said reference voltage is at a low voltage level; in said exposure phase, said second switch means is switched off; said common voltage is at said high voltage level; said input video signal is at said low voltage level, and said reference voltage is a high voltage level; and in said readout phase, said common voltage is at a low voltage level, said reference voltage is at a low voltage level, and said first switch means connects said data line to an input of said charge-sensing circuit.

The charge-sensing circuit may be an integrator and said control means may be configured to reset said integrator during an initial part of said readout phase.

A third switch means may be interposed between said pixel element and said sensor element. The third switch means may be controlled so as to allow said sensor element to be connected to said data line only during said exposure phase.

The sensor element may be a light-sensitive element or a photo-conductor element or a photo-diode, in which case the display apparatus may further comprise a light pen for entering the user's graphical input.

Alternatively, the sensor element may be a magnetic-field sensitive element, such as a magnetoresistive element. In this case the display apparatus may further comprise a magnetic pen for entering the user's graphical input.

As a further alternative, the sensor element may be a pressure-sensitive element, whereby the user's graphical image can be entered by the exertion of pressure.

The display apparatus may further comprise a fourth switch means for triggering the start of the exposure phase. A fifth switch means may be included for triggering the start of the pre-charge phase.

In accordance with a second aspect of the present invention, a method for operating a display apparatus as claimed in claim 1 comprises: displaying a predetermined image on the display screen of the apparatus, whereby the pixel elements are set to their respective first charge states; enabling the sensor elements; entering the user's graphical input, whereby the pixel elements are set to their respective second charge states; and reading out said second charge states.

The entering step may involve drawing the user's graphical input on the display screen by means of a light pen or a magnetic pen.

Constituting a third aspect of the invention is a method for operating a display apparatus as claimed in claim 1, in which the method comprises: setting said pixel elements to said first charge state, said first charge state being the same for all the pixel elements; enabling the sensor elements; exposing the pixel elements to an external image, said external image forming said user's graphical input and setting the pixel elements to their respective second charge states; and reading out said second charge states.

### IV. BRIEF DESCRIPTION OF THE SEVERAL VIEWS OF THE DRAWINGS

Embodiments of the invention will now be described, by way of example only, with the aid of the attached drawings, of which:

FIGS. 1A and 1B are circuit and perspective representations, respectively, of a prior-art display arrangement;

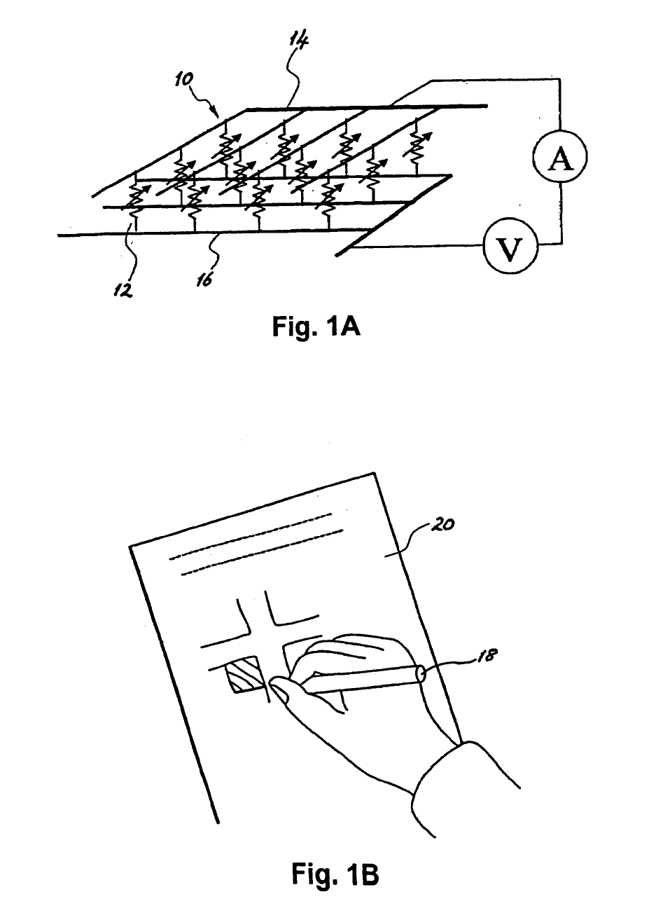

FIGS. 2A and 2B are block-schematic and perspective representations, respectively, of a further prior-art display arrangement;

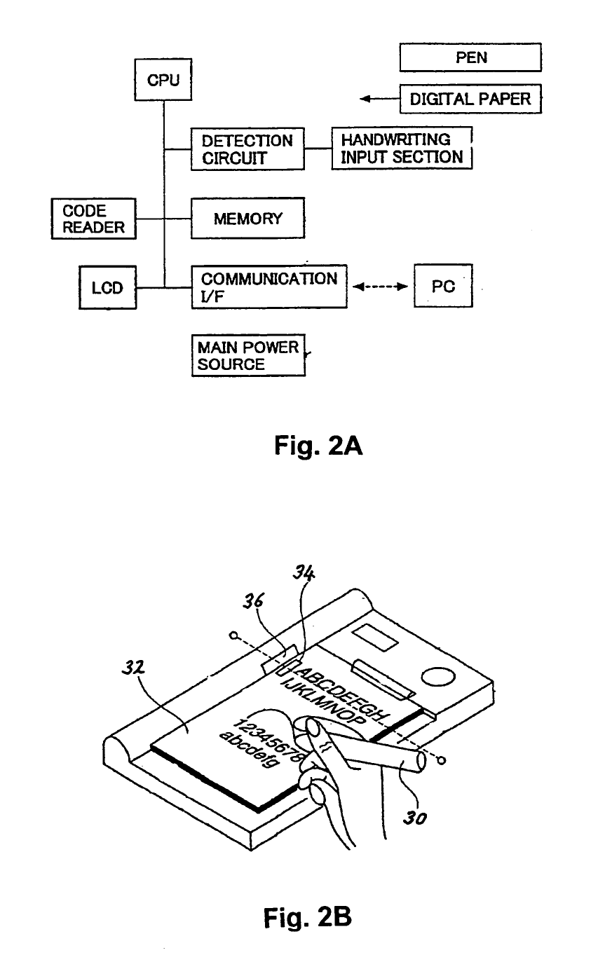

FIG. 3 is a schematic representation of a still further prior-art display arrangement;

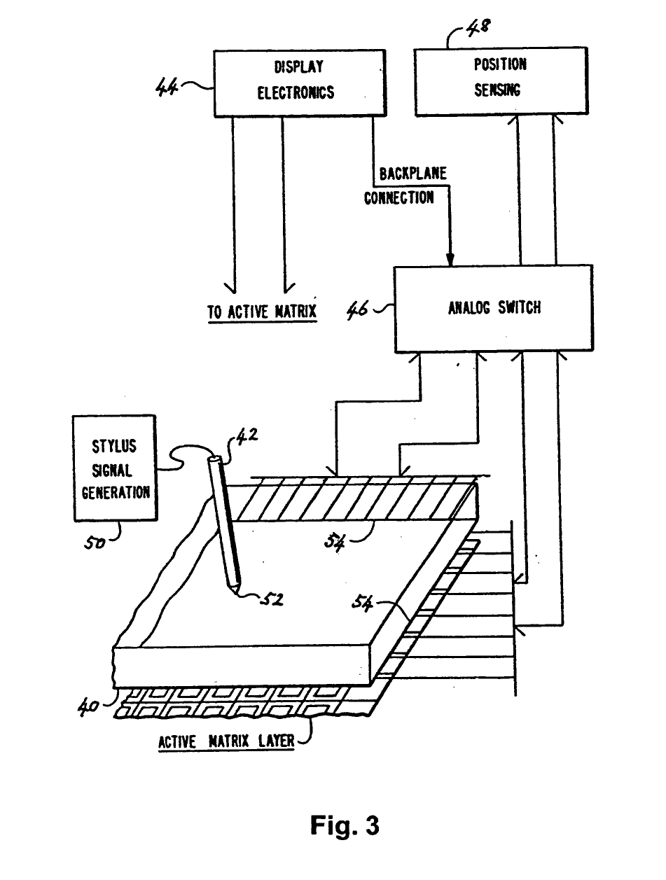

FIG. 4 is a simplified schematic diagram of a known active-matrix electrochromic display;

FIG. 5 is a schematic diagram of a first embodiment of a display apparatus in accordance with the present invention;

FIGS. 6 and 7 are flow diagrams illustrating two modes of operation of the display apparatus of FIG. 5;

FIG. 8A is a circuit diagram showing a more detailed realization of the display apparatus of FIG. 5, while FIGS. 8B and 8C are timing diagrams associated with the circuit diagram of FIG. 8A;

FIGS. 9A and 9B are variants on the arrangements shown in FIG. 8A and FIGS. 8B or 8C, respectively;

FIG. 10 is a partial circuit diagram illustrating a variant way of controlling a sensor element employed in a display apparatus according to the present invention, and FIG. 11 is a circuit diagram of an alternative form of charge integrator, that may be used in a display apparatus in accordance with the present invention.

### V. DETAILED DESCRIPTION

The present invention involves the use of an electrochromic display (ECD), and in particular an active-matrix form of such a display (an AMECD).

An AMECD is a reflective display consisting of pixel elements formed by electrochromic materials, which exhibit two coloration states, depending on their charge condition. These two states are, firstly, clear and transparent when discharged (commonly referred to as a “bleached” state) and, secondly, opaque and black (or coloured) when charged. Different colours of electrochromic materials are available—e.g. Persian Blue. Pixel driver circuits are used to control the charging or discharging of individual electrochromic pixels. In what follows, a monochrome display with black electrochromic pixels on a white background will be used for simplicity. The display can be on glass or a flexible substrate.

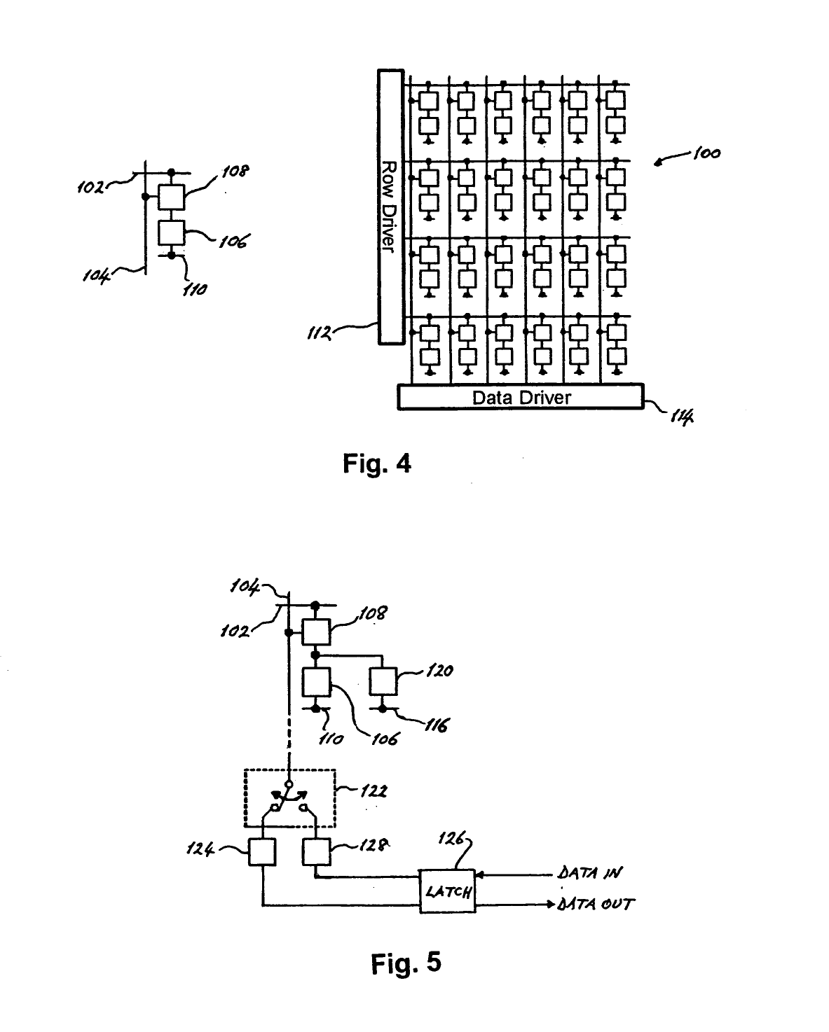

A schematic diagram of a typical AMECD is illustrated in FIG. 4. The AMECD 100 consists of a series of row electrodes (row-select lines) 102 and a series of column electrodes (data lines) 104. A pixel element 106 is located at the intersection of a row and a column electrode. Within each pixel, the row select line controls a pass transistor 108 to transfer the data voltage to the electrochromic pixel. All the pixels share the same common electrode 110. The row-select lines 102 and the data lines 104 are driven by a row driver 112 and a data driver 114, respectively.

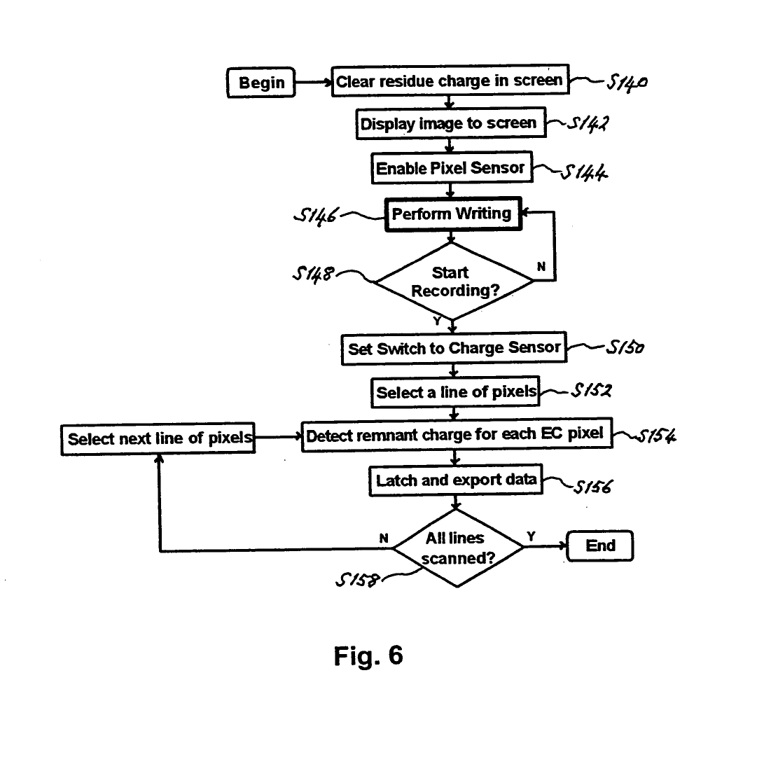

In a first embodiment of the present invention (see FIG. 5), the AMECD 100 shown in FIG. 4 is complemented by the addition of the following components: a sensor element 120 in parallel with the electrochromic pixel element 106, a switch unit 122, a charge-sensing circuit 124 and a bi-directional latch 126. The sensor element 120 can be a photo-conductor, a photo-diode or a magnetoresistive device, for example. As in FIG. 4, the pixel element 106 is fed from a common voltage on line 110. In addition, however, the sensor element 120 is fed from a bias voltage 116.

To write an image to the display from existing video data, the switch unit 122 is operated so that it connects the data line 104 to the output of an input buffer 128. The row driver 112 then performs scanning of the row lines 102. Input video data stored in the latch 126 produces a voltage on the output of the input buffer 128, which provides enough current to drive the data line 104. Scanning of the row lines 102 causes the pass transistors 108 of each row in turn to be switched on, and as a result the voltages on the data lines charge the electrochromic pixels 106 in that row to—in this example—a black state, accordingly. At this time the sensor element 120 is at high impedance, since it is assumed that it is not subjected to any appreciable level of light. The image now displayed on the screen persists for a given time due to the charged state of the pixels.

To read an image, which is being displayed, the switch unit 122 is operated so that it connects the data line 104 to the input of the charge-sensing circuit 124. The row driver 112 performs scanning of the row lines 102, as in the writing operation. This time the data line 104 is charged to a voltage, which is the same as the potential on the electrochromic pixel at the intersection of the data line and row line concerned. This removes some of the charge from the scanned row of pixels. The discharge current flows from the pixel, through the pass transistor 108, the data line 104 and the switch unit 122 into the charge-sensing circuit 124. The charge-sensing circuit, in one realization thereof, functions as a charge integrator. If the detected charge exceeds a threshold value, it is judged that the pixel is in its black state. It should be appreciated that, although this readout function is essentially a destructive form of readout, since charge is removed, provided the amount of charge removed is significantly less than the original charge on the pixels, the quality of the display will not suffer significantly. This is important especially where the image is a grey-scale image.

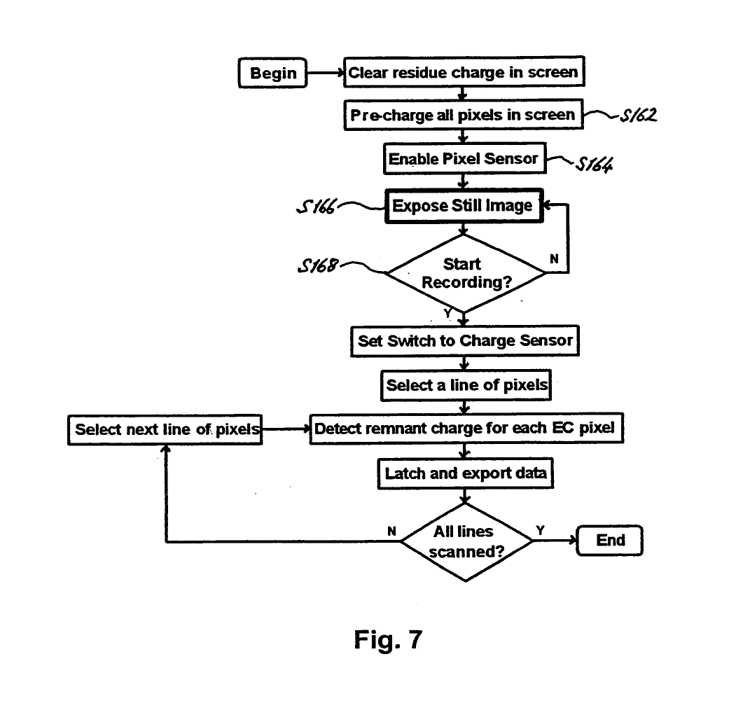

The handwriting mode of operation of this first embodiment of the invention is summarized in the flow-chart of FIG. 6.

Firstly, in step S140 the residual charge on the screen is removed by setting all data lines to the common-electrode potential and scanning the row lines in turn. Sufficient time is allowed for the charge to be removed. Then in step S142 an external controller writes an image, represented by the data signal on the input of the latch 126, to the display. It is assumed that this image is, for example, a registration form or a check list. In the present example (black on white), this form or list consists of black lines and other graphics on a white background. The display is then powered down and disconnected from the external controller. However, due to the charge-storage action of the ECD pixel elements, the image remains on the display.

In step S144 the pixel sensor 120 is enabled and the user fills in the various fields in the form or list by inputting his handwriting or drawing via a pressure activated pen (step S146). The enabling step may, in one version of this embodiment, occur when the user presses the tip of the pen against the surface of the display. At any point where the pen touches the screen, a corresponding mark will be produced on the display, just like the traditional form of writing using pen or pencil and paper. Where the pen is a light pen and the sensor 120 is, say, a photodiode, pressing the pen tip against a part of the display will cause a current to flow through one or more sensors 120 in that region and this current will pass into the associated ECD pixels 106, increasing the charge on those pixels. This, in turn, changes the displayed state of these pixels and causes a black mark to be displayed in that region. The handwriting being displayed will persist on the screen in the same manner as the form or list already being displayed.

The use of the pen to create a black mark, as just described, requires the use of a power source in order to impose charge upon the otherwise unbleached (discharged, i.e. white) pixel elements. However, current flows from the power source only while the pen is being used. No current is required to be supplied for any continuous scanning or updating operation, as is the case in the prior-art arrangements. On the other hand, where the pen is used to create a white mark on a black (or coloured) background, no power source is required to be connected to the pixel element or sensor element during the time the pen is being used. This is because the pen causes some of the charge to be removed from the unbleached pixel elements, over which it passes, by means of the sensor elements. Hence the pixel elements themselves act as a current source as far as the sensor elements are concerned.

The following steps are performed to record the new image on the screen as new video data to be output to the controller from the latch 126. Firstly, a check is made at step S148 whether or not recording is to start. This may occur by firstly connecting the display to the controller and then pressing a button to command the controller to read the page of data from the display panel. Pressing the button changes over the switch unit 122 so that the data line 104 is connected to the charge-sensing circuit 124 (step S150). A row of pixels is then selected (step S152) and the charge on each pixel in that row is sensed by the charge-sensing circuit 124 (step S154) and the result is output to the latch 126 (step S156). A check is then made at step S158 to determine if all the rows have been scanned. If not, the next row of pixels is selected and the charge on the pixels in that row is sensed. When all the rows have been scanned, the routine is ended. All the new video data has at that point been latched and output to the controller, where it can be suitably processed.

FIG. 7 shows an alternative scenario, in which, instead of loading the screen with a predetermined image (e.g. a registration form) and using a light pen to fill in the various fields in the image, an external visible image is impressed upon the screen, e.g. by projecting an image thereupon. All the various steps in this alternative scenario are the same as in the FIG. 6 scenario, except for steps S142, S144 and S146, which are replaced by steps S162, S164 and S166, respectively. In step S162, following the clearing of the residual charge from the screen pixels, all the pixels may be provided with the same initial charge. This sets the background tone of the display. However, if the black-on-white scheme used in the FIG. 6 example is still desired, it will be necessary to provide a white background, which in turn means staying with the zero-charge situation provided in step S162. In that case step S162 is not necessary.

In step S164 the sensor elements are enabled ready to receive the external image, and in step S166 these sensor elements are subjected to this image. This image is retained by the display and the image-recording step is commenced in step S168 (equivalent to step S148) and continued through the remaining steps, which are the same as steps S150, S152, S154, S156 and S158 in FIG. 6.

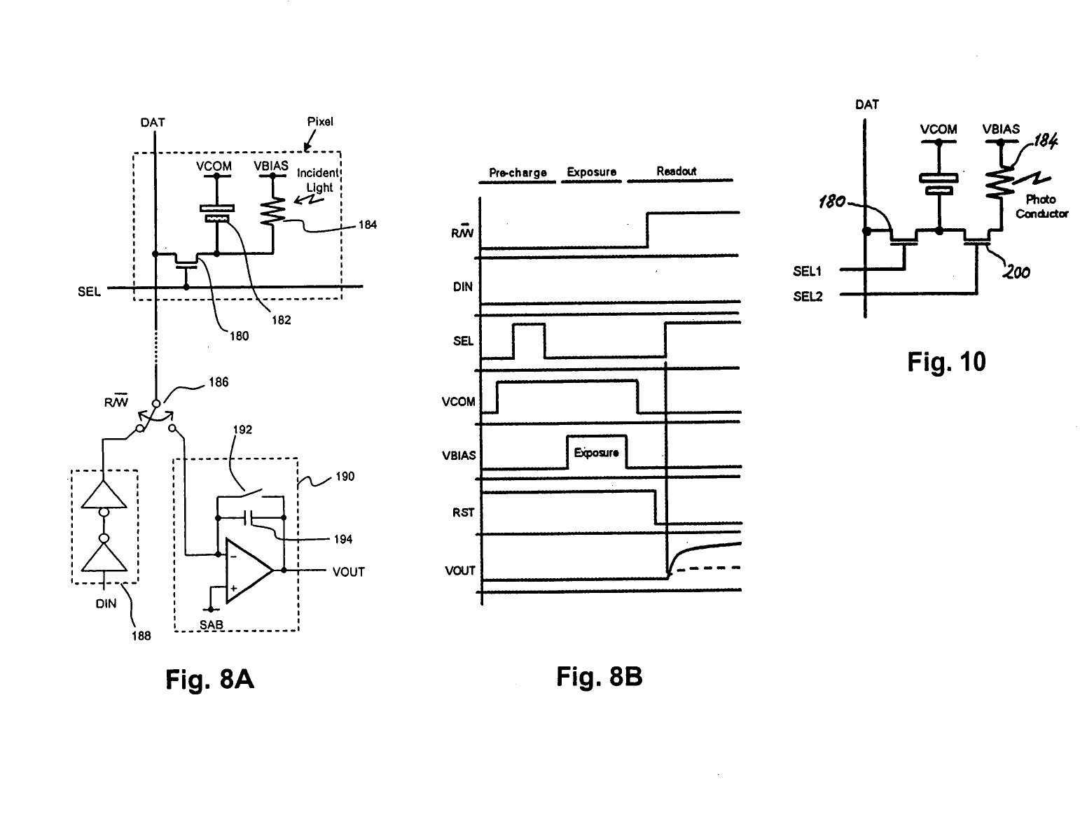

A practical realisation of the image recorder just described in connection with FIG. 7 is illustrated in FIG. 8A. FIG. 8B is a timing diagram relating to the FIG. 8A circuit.

The circuit shown in FIG. 8A comprises the row and data lines, here called SEL and DAT, respectively, which are connected to the gate and source of a FET 180. The drain of the FET 180 is connected, firstly, to an electrochromic (EC) pixel element 182, the other end of which is held at voltage V_{COM}, and, secondly, to a photo-conductor 184, the other end of which is supplied with a bias voltage, V_{BIAS}. As in FIG. 5, the data line DAT is taken to the common terminal of a changeover switch 186. This terminal connects selectively with either the output of an output buffer 188 or the input of an integrator stage 190. The input of the output buffer 188, designated as DIN, is fed with a voltage V_{DIN}, while the output of the integrator stage 190 is a voltage V_{OUT}, which is subjected to further processing, as required. The integrator 190 includes a reset switch 192 shunting the integrator capacitor 194. The non-inverting input of the integrator is fed with a reference voltage V_{SAB}. There is a buffer 188 and integrator 190 for each of the data lines DAT in the display.

The circuit operates in three phases, as shown in FIG. 8B. In the pre-charge phase V_{DIN} is low and is applied to the data line DAT via the output buffer 188, and the EC pixels are initially fully charged by sending V_{COM} high and V_{BIAS} low. Shortly after V_{COM} has gone high, the row-select voltage V_{SEL} goes high, in order to turn on pass transistor 180. This renders the pixel in question black. Preferably, the whole display is turned black by making V_{DIN} for all the data lines low and either selecting the row lines in turn or selecting them all simultaneously. The latter option turns the whole screen black at once, while the former option turns each row of pixels black in turn until the whole screen is black. At the end of this pre-charge phase, transistor 180 is turned off by sending the voltage V_{SEL} on the row-select line low again. At the end of the pre-charge period the EC pixels retain their charge and maintain their black state until the start of the second phase.

In the second phase, the exposure phase, V_{BIAS} is taken high to nominally the same potential as V_{COM} (i.e. 1.2V). This places the photo-conductor 184 across the EC pixel. The photo-conductor is normally high-resistance in the dark state. However, when it is subjected to a light source—in this example, from an image which is incident on the display screen, but the same thing occurs when a light pen is used—its resistance decreases. This removes some of the charge from the EC pixel, which therefore becomes modulated by the light incident on the photo-conductor 184. The resistance of the photo-conductor is determined by the intensity of the incident light, while the width of the V_{BIAS} pulse governs the length of time over which this resistance shunts the EC pixel. (Note that this shunting action occurs for all of the pixels in the display simultaneously). As a result, at the end of the exposure period, defined by the V_{BIAS} pulse going low again, a given amount of charge has been removed from each pixel, resulting in a given level of bleaching in each of the pixels. The use of different intensity light sources for each photo-conductor (arising, in this example, from different parts of an incident image) will result in different greyscale values. At the end of the exposure phase the incident light is removed. Since the EC pixels are non-volatile, they retain their new level of charge until the image is read. The resulting image on the screen is a positive copy of the incident image.

While it has been assumed that V_{BIAS} in its high state will be the same as V_{COM}, this is not essential. Indeed, making V_{BIAS}, when high, different from V_{COM} can vary the amount of charge taken out of the pixel element during the exposure phase. Making V_{BIAS}, when high, higher than V_{COM} will accelerate the extraction of charge from the pixel element, while making it lower will slow such extraction down. Hence the desired exposure period can be controlled by one or both of the width of the V_{BIAS} pulse and the value of V_{BIAS} in its high state.

In the third phase, which is the readout phase, V_{COM} is sent low so as to be nominally at the same potential as V_{BIAS} in its low state, the data line is switched over to the charge integrator 190 by operating the switch 186 and the reset switch 192 in the integrator 190 is closed in order to reset the output of the integrator to potential V_{SAB} appearing on the non-inverting input of the integrator. Transistor 180 is then turned on (V_{SEL} going high) in order to partially discharge the pixel element through the data line, which is now connected to the integrator. Charge removed from the pixel element charges up the capacitor 194 in the integrator, causing the voltage V_{OUT} to rise, as shown in FIG. 8B. Where the pixel in question is still dark (since much of the original charge is still resident in the pixel element), this corresponds to a relatively large amount of charge transferred to the capacitor 194 in a given time, resulting in a high voltage V_{OUT}. The converse is also true, so that a bright pixel will produce a low voltage V_{OUT}, due to the lower charge resident in the EC pixel at the end of the exposure phase. In practice, as already mentioned earlier, the amount of charge drawn from the pixel elements during the readout phase is limited, since otherwise the quality of the visible image on the screen would noticeably deteriorate. Hence the readout phase is of limited duration in order to provide a given discharge period.

FIG. 8C shows a modification of the FIG. 8B procedure. FIG. 8C differs in two ways from FIG. 8B: firstly, the use of a variable value of V_{BIAS} in order to increase or shorten the exposure time, as explained earlier (see the dotted extension to the V_{BIAS} pulse during the exposure phase in FIG. 8C); secondly, the selection of each row in turn (e.g. row n, row n+1, etc) during the readout phase. In that event, different values of V_{OUT} are output by the charge-sensing circuit 190 for each row selected. These values correspond to the sensed charge relating to successive pixel elements connected to the same data line DAT.

The signal V_{OUT} can be used for further digital processing, for example in a computer to which the display may be connected, or may be simply stored in local memory. The stored image data can be used to refresh the displayed image, for example, by feeding back the signal V_{OUT} to the output buffer 188 as signal DIN. In that case the timing diagram FIG. 8B will include, after the end of the readout phase, one or more refresh phases for maintaining the image on the screen. In the event that a user wishes to impress another image on the screen, he simply has to operate a switch, which will start off the pre-charge phase once again, as shown in FIG. 8B or FIG. 8C.

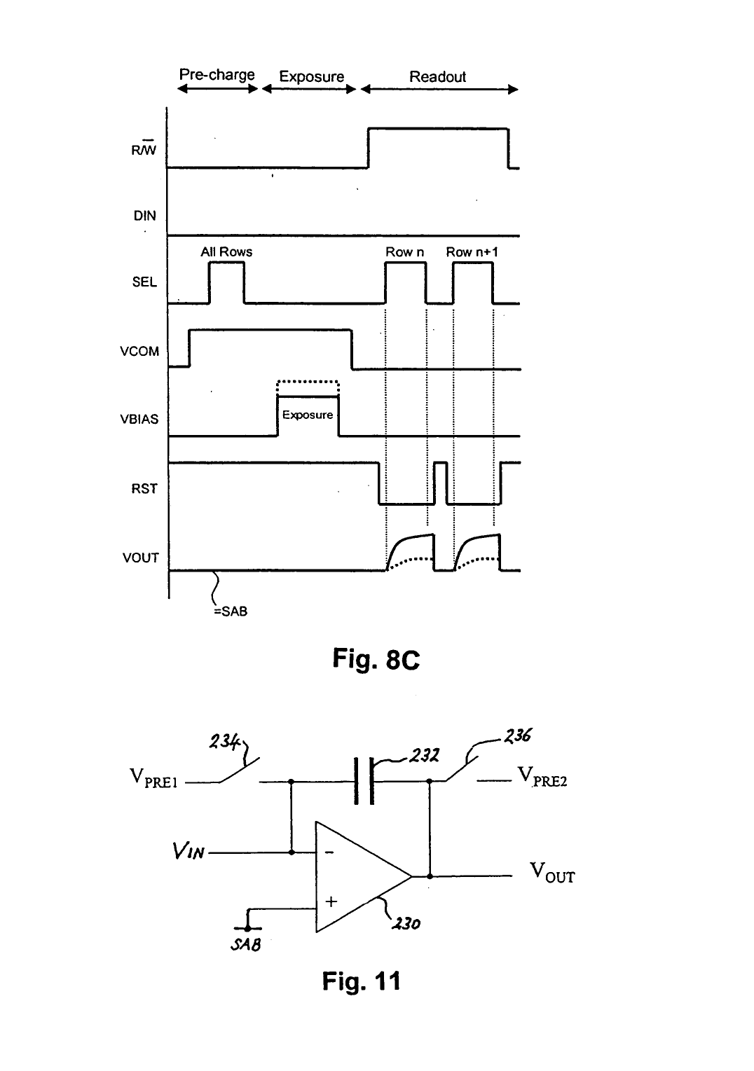

For greyscale readout, the integrator is level adjusted and further amplified before being connected to an analog to digital converter (ADC). An exemplary arrangement for achieving this is shown in FIGS. 9A and 9B. FIGS. 9A and 9B correspond to FIGS. 8A and 8C, respectively, but with the following differences. Firstly, FIG. 9A further includes an amplifier 220 and an analogue-to-digital converter (ADC) 222 connected in series to the output of the integrator stage 190. Amplifier 220 provides level-shifting and amplification of the integrator output voltage, while the ADC 222 samples the analogue voltage on the output of the amplifier/level-shifter 220 and outputs a multi-bit digital signal on lines 224. The binary value of the ADC output provides an indication of the greyscale value of the charge present on the pixel element for the row in question. Sampling of the amplifier output voltage occurs when a sampling signal SAM goes high (see FIG. 9B, bottom trace), upon which the digital output corresponding to the charge on the pixel element for the column and row in question is developed and provided for further processing.

The advantages of the described arrangement include:
(a) The image is a positive image.
(b) The read-out image has a greyscale capability, which enhances the image quality.
(c) The required exposure time is easily controlled by the width of the V_{BIAS} pulse (and/or value of V_{BIAS}, when high), and
(d) The electronics require only a single supply-voltage, i.e. positive with respect to ground.

Examples of applications for such an image sensor are an x-ray detector, which uses white-on-black, and a contact-type image sensor. A contact-type image sensor is similar to a sheet of carbon copy paper, and comprises a 2-dimensional sensor bearing the same physical dimension of the source document (e.g. a sheet of A4 paper). The paper is simply placed over the 2-dimensional sensor and the user draws or writes the desired graphics or text on the paper, leaving behind on the screen a “carbon-copy” of the drawn graphics or text. Such an image sensor is a low-cost sensor that requires no bulky optical and moving parts like those found in a traditional scanner-type image sensor. Since the paper used for the source image is assumed to be opaque, the pen used for the “carbon-copying” process will most likely be a literal pen, which depresses a pressure-sensitive pad comprising part of the screen. Alternatively, if such a pen can be provided with a permanent magnet near the pen tip, the sensor elements may be, e.g., magneto-resistive elements.

The circuit can be readily converted to the use of a negative image, instead of a positive one. To achieve this, V_{COM} is sent low during the pre-charge phase, but is sent high (e.g. to 1.2V), and V_{BIAS} is sent low (e.g. 0V), during the exposure phase. This means that, during the pre-charge phase, all EC pixels are discharged (bleached), or at most only to a very low level of charge. This is because the voltage, V_{DIN}, on the DIN line will still be low and this will be imposed, via the output buffer 188, on the data line via the switch 186. On the other hand during the exposure phase, since V_{COM} is high and V_{BIAS} is low, the EC pixels will charge up, rather than discharge, through the photo-conductors 184. Depending on the length of the exposure period (width of V_{BIAS}) and the intensity of light striking each individual photoconductor, an image will be produced on the screen, which will be black-on-white—that is, the negative of the original incident image.

It is preferable if the exposure phase is triggered when required, since this can save power. Such triggering can be achieved by, for example, the user operating a switch when an image is about to be exposed, or by incorporating a touch-sensitive element in the display screen. The latter option assumes that a light pen, or similar, is to be used to enter an image, since then the user only has to place the light pen against the display in order to operate the touch-sensitive element and start the triggering action.

The other mode of triggering is to do this automatically soon after the pre-charge phase. This has the undesirable drawback, however, that the image already on the screen will be subject to ambient light during the period between the start of the exposure phase and the moment the user imposes an actual image on the sensor elements. This ambient light will have the effect of drawing off charge from the pixel elements, thereby reducing the image contrast on the screen when an image is finally imposed.

Ambient light present during the period between the end of the pre-charge phase and the start of the exposure phase is unlikely to be a problem in the embodiment being described. This can be explained with reference to FIGS. 8A and 8B. In FIGS. 8A and 8B the pixel element 182 can be seen to have applied to it, during the pre-charge phase, voltages V_{COM} in its high state and V_{DIN} in its low state, while the sensor element 184 has applied to it voltages V_{BIAS} in its low state and V_{DIN} in its low state. (V_{DIN} is applied to the data line through the output buffer 188). If it is assumed that V_{BIAS} in its low state is the same as V_{DIN} in its low state (e.g. 0V), then zero current will flow through the sensor element 184 during the pre-charge phase. At the moment the select voltage V_{SEL} goes low, transistor 180 turns off, leaving the pixel element with floating charge. Since V_{BIAS} is still the same as V_{DIN} (0V), there will be no discharge of the pixel element through the sensor element. Indeed, the sensor element will act to retain the charge on the pixel element, which is desirable. This applies regardless of the effect of ambient light on the sensor element. Thus, it is immaterial what the resistance of the sensor element is, due to ambient light, during the time between the pre-charge and exposure phases.

The effect of ambient light present between the start of the exposure phase and the imposing of an image on the sensor elements has already been mentioned. Ambient light can, however, also be a problem during the rest of the exposure period as well. This applies whether an image is being handwritten to the pixels via a light pen, for example, or is being projected onto the pixels as in incident image. To mitigate the ill effects of ambient light during the exposure period generally, the invention envisages the use of a sensor, which senses the ambient light to produce an ambient-light sensing signal. This signal is then used to vary the width of the V_{BIAS} pulse and/or the value of V_{BIAS} when it is high. Increasing levels of ambient light act to decrease the pulse width or reduce the value of V_{BIAS} in its high state.

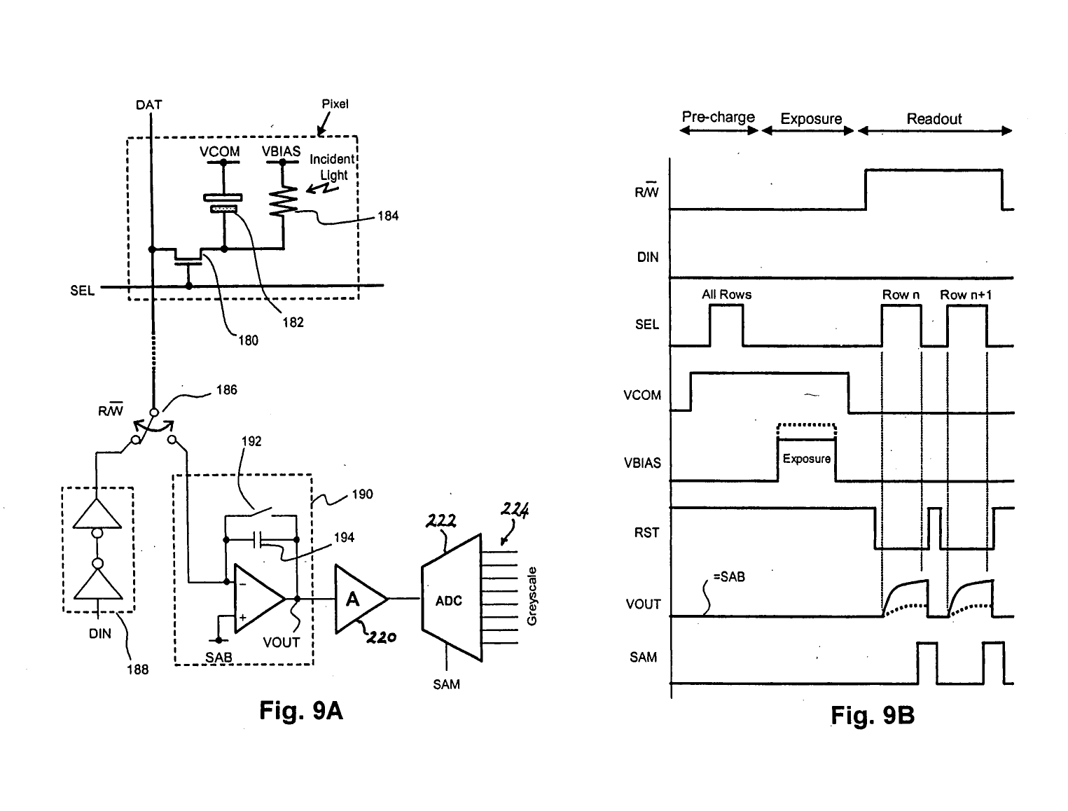

Another way of controlling the effects of ambient light is illustrated in FIG. 10. In FIG. 10 the sensor element 184 is isolated from its associated pixel element by means of a switch 200. The gate of switch 200 is fed from a second select signal, SEL2, the gate of the pass transistor 180 being fed from the existing select signal, which is redesignated as a first select signal SEL1. Due to the inclusion of switch 200, it is possible to gate the shunting effect of the sensor element on the pixel element so that it occurs only over a short period. Thus, for instance, SEL2 can be arranged to go high just before an exposure is about to take place, and to go low again at the start of the readout phase. One way to do this is to use V_{BIAS} as signal SEL2. This assumes, of course, that V_{BIAS} assumes values capable of driving the switch 200.

It was mentioned earlier that the sensor element may be not only a photo-conductor, but also a photo-diode or a magneto-resistive element. The latter assumes the use not of a light pen, but of a pen with a magnet at the end of it. As also already explained, a light-sensitive sensor element can be activated also by radiant light projected onto it from an external image. The use of such sensors allows the invention to be used as a writing pad (e-paper), allowing the convenient filling in of such things as registration forms, the checking-off of check-lists, etc. Another application of the invention is as a fingerprint recorder. In that case, the sensor will not be light-sensitive or magnetic, but will be a pressure-sensitive element, which is activated by the pressure of the user's finger or thumb on the screen.

Although the invention has been described in connection with an active matrix of EC pixels, it is also applicable to a passive matrix of such pixels. This has drawbacks, however. This is because, in a passive matrix arrangement, the stored charge will be redistributed along the vertical and horizontal electrodes causing the so called “cross talk” phenomenon. For example, a pixel originally black is turned white due to discharge of the pixel using a light pen. Soon, however, in a passive matrix it will return to black, because the top and bottom electrodes are shared by pixels that are charged. As a result, there is the risk that the written image will quickly degrade. The use of a pass transistor 180 in the active matrix arrangements described earlier avoids such charge sharing and consequent risk of rapid image degradation. Nevertheless, provided an image on the screen is refreshed often, it may be practicable to apply the invention to a passive matrix. Of course, such frequent refreshing of the image will consume more power, which to some extent runs counter to what the invention is trying to achieve.

Furthermore, whereas the figures show a positive-voltage system—that is, one in which a single positive voltage-supply rail is used in addition to ground—a negative-voltage system may alternatively be used. This is likewise a single-voltage supply with respect to ground.

The charge sensor 190 shown in FIG. 8A has been shown as a charge integrator. However, it may take other forms, such as a simple inverter or comparator, a cross-coupled sense amplifier, or a current source load, for example. It is true that, when a simple device such as an inverter or comparator is employed, this cannot by itself directly sense charge, in contrast to an integrator. However, it can sense the voltage on the data line. Provided the parasitic capacitance on the data line is sufficiently small, when the SEL line goes high and turns on the pass transistor 180 (see FIG. 8A), the charge on the pixel electrode will be partly transferred to that parasitic capacitance, changing the voltage on the data line. It is this voltage that will be sensed by the inverter or comparator, and this provides a measure of the charge on the pixel electrode.

In practice, the stored voltage on the pixel element is detected by the fixed threshold voltage of the inverter or by a variable threshold voltage on the other input of the comparator, whichever is used. When an inverter is used, and a greyscale capability is required, the greyscale information can be detected by performing a series of consecutive readouts. Each readout consumes approximately the same amount of charge, and an estimate of the greyscale value may be obtained by counting the number of readouts required before all the charge on the pixel element is removed. This, of course, is a destructive readout system, in contrast to the largely non-destructive readout system described earlier. When a comparator is used, the greyscale information may be gleaned by varying the reference voltage, while still performing a series of consecutive readouts.

The use of a simple inverter or comparator does not suit every application. The main criteria for this is, firstly, the size of the display and, secondly, the display resolution. In the case of the display size, the larger the size, the greater the parasitic data-line capacitance—hence inverter or comparators suit smaller displays. As regards the resolution, it is the case that, the higher the display resolution, the smaller the pixel storage capacity, which in turn limits the readout capability. Hence an inverter or comparator is more readily used with a lower-resolution display. When these two criteria are not met, it is best to use a device such as a charge integrator.

Although, according to FIG. 8A, it has been assumed that voltage V_{COM} on one side of the pixel elements will be in its low state during the readout phase, it may alternatively remain high at the end of the exposure phase (see FIGS. 8B and 8C). When this occurs, however, the voltage conditions on the data line entering the integrator 190 will be reversed, leading to the integrator output voltage V_{OUT} going low and possibly attempting to go below ground, depending on the value of voltage SAB on the non-inverting input of the integrator. This would require the inclusion of a negative voltage supply relative to ground, which is undesirable. In order to avoid this, the integrator may take an alternative form, which is the subject of a co-pending patent application in the name of the present applicants, European patent application 03254061.9, publication no. EP1376603, published on 2 Jan. 2004.

FIG. 11 shows a simplified representation of this alternative type of integrator. The integrator comprises an operational amplifier 230 with a capacitor 232 between its output and its inverting input. One end of capacitor 232 is connected to a switch 234, while the other end of capacitor 232 is connected to a switch 236. These two switches are fed with preset voltages V_{PRE1} and V_{PRE2}, respectively. The inverting input of the integrator forms the input voltage, V_{IN}, while the output of the integrator forms the output voltage, V_{OUT}.

The operation of the integrator is as follows. After the switch 186 has changed over to its read setting, by signal R/W going high, but before the select line SEL goes high, switches 234 and 236 are closed, thereby placing a voltage equal to the difference between V_{PRE1} and V_{PRE2} across the capacitor 232. If V_{PRE2} is more positive than V_{PRE1}, then the capacitor will be charged to a preset voltage which, due to the virtual-earth action of the inverting input, will place the integrator output voltage, V_{OUT}, higher than the voltage on the SAB line by an amount V_{PRE2}−V_{PRE1}. Once the preset voltage has been placed across the capacitor, switches 234 and 236 are opened, removing V_{PRE1} and V_{PRE2} from the capacitor. The select line, SEL, now goes high and charge from the pixel element is transferred to the capacitor 232 through the input V_{IN}. This time, however, since V_{OUT} starts from a high value above SAB, it does not reach ground voltage, not even if a significant amount of charge becomes transferred from the pixel element. In order to ensure this, it is necessary to place a sufficiently high preset voltage, V_{PRE2}−V_{PRE1}, across the capacitor. The value of this preset voltage is easily calculated from a knowledge of the average pixel-element charge capacity, the value of the capacitor 232 (and also the value of any parasitic capacitance on the data lines), and the width of the select pulses on the SEL line. Switches 234 and 236 are closed just before each row of pixel elements is read, i.e. just before the SEL line goes high for each successive row.

Although, during the course of the description, certain voltages were quoted as representative examples of practical voltages that may be applicable to the circuits being described, the present invention is in no way limited to such voltages.

What has been described is a display apparatus, which includes along with each EC pixel element a sensor element, upon which can be impressed a graphical image. This may be through the use of a light pen or magnetic pen, for example, or by the projection of an external image on the screen. The sensors, when they receive the graphical image, module their respective pixel elements by changing the amount of charge on them. The modified charge present on the pixels gives rise instantly to a modified image appearing on the screen. This modified image is retained due to the inherent charge-retention capability of the underlying EC technology. In addition the new image is read out as modified image data, which can be used to periodically refresh the displayed image, if necessary, and for subsequent further processing, as required.

Such a system has great advantages for the user. Principally, the user can make notes, or draw lines, on the screen—either on a blank background or on an already displayed graphical image, such as a form to be filled in—and these notes or lines will appear straightaway without the need to refresh the screen using the digital driver circuitry of the main display driver. Thus the software latency, which exists in the known systems, is absent here. Secondly, the lack of a need to rescan the display, in order to detect those pixels which have changed their charge, means that power consumption is reduced. This is important where the display apparatus is portable, which is often the case with this technology. Thirdly, the displayed image is non-volatile, since the EC pixels retain their charge.

1. A display apparatus comprising:
a plurality of scanning lines;
a plurality of data lines;
a plurality of electrochromic pixel elements positioned at each of the plurality of intersections of the plurality of data lines and the plurality of scanning lines;
a plurality of sensor elements connected to the plurality of electrochromic pixel elements, each of the plurality of sensor elements being sensitive to a graphical input, thereby to change a charge state of each of the plurality of electrochromic pixel elements respectively; and
a control means, which is configured to allow the plurality of electrochromic pixel element to be selectively set to a first charge state corresponding to a first display state, or to a second charge state corresponding to a second display state, the second display state reflecting the graphical input.

2. The display apparatus according to claim 1, the control means including a first switch means which is connected to one of the plurality of data lines and is configured to selectively connect the one of the plurality of data lines to an input video signal for setting the plurality of electrochromic pixel elements to the first charge state, or to a charge-sensing circuit for reading out the second charge state of the plurality of electrochromic pixel elements.

3. The display apparatus according to claim 2, the control means being configured to perform three sequential phases of operation:
a pre-charge phase, in which said first charge state of the pixel element is set;
an exposure phase, in which the sensor element is exposed to said user's graphical input, and
a readout phase, in which said second charge state of the pixel element is read out.

4. The display apparatus according to claim 3, one end of one of the plurality of electrochromic pixel elements and one end of one of the plurality of sensor elements being electrically coupled to each other, the other end of one of the plurality of electrochromic pixel elements being electrically connected to a common voltage for all of the plurality of electrochromic pixel elements, and the other end of one of the plurality of sensor elements being electrically connected to a reference voltage.

5. The display apparatus according to claim 4, further comprising:
a second switch means electrically connected to at least one of the plurality of data lines and to at least one of the plurality of electrochromic pixel elements and controlled by a respective one of the plurality of scanning lines.

6. The display apparatus according to claim 5, the control means being configured such that:
in said pre-charge phase, said second switch means is switched on, thereby to connect said pixel element and said sensor element to said data line; said first switch means connects said data line to said input video signal; said input video signal is at a low voltage level; said common voltage is at a high voltage level and said reference voltage is at a low voltage level;
in said exposure phase, said second switch means is switched off; said common voltage is at said high voltage level; said input video signal is at said low voltage level, and said reference voltage is a high voltage level; and
in said readout phase, said common voltage is at a low voltage level, said reference voltage is at a low voltage level, and said first switch means connects said data line to an input of said charge-sensing circuit.

7. The display apparatus according to claim 6, the charge-sensing circuit being an integrator and the control means being configured to reset the integrator during an initial part of the readout phase.

8. The display apparatus according to claim 5, further comprising:
a third switch means interposed between at least one of the plurality of electrochromic pixel elements and at least one of the plurality of sensor elements.

9. The display apparatus according to claim 8, the control means being configured to control the third switch means so as to allow at least one of the plurality of sensor elements to be electrically connected to one of the plurality of data lines only during the exposure phase.

10. The display apparatus according to claim 1, each of the plurality of sensor elements being a light-sensitive element.

11. The display apparatus according to claim 10, the light-sensitive element being a photo-conductor element or a photo-diode.

12. The display apparatus according to claim 10, further comprising:
a light pen for entering the graphical input.

13. The display apparatus according to claim 1, each of the plurality of sensor elements being a magnetic-field sensitive element.

14. The display apparatus according to claim 13, the magnetic-field sensitive element being a magnetoresistive element.

15. The display apparatus according to claim 13, further comprising:
a magnetic pen for entering the graphical input.

16. The display apparatus according to claim 1, each of the plurality of sensor elements being a pressure-sensitive element, the graphical image being configured to be entered by the exertion of pressure.

17. The display apparatus according to claim 6, further comprising:
a fourth switch means for triggering the start of the exposure phase.

18. The display apparatus according to claim 17, further comprising:
a fifth switch means for triggering the start of the pre-charge phase.
